(19) United States
(12) Patent Application Publication
(10) Pub. No.: US 2014/0366617 A1
(43) Pub. Date: Dec. 18, 2014

(54) METHOD AND SPECIMEN FOR TESTING HANDLING IN TIRES

(71) Applicant: E I DU PONT DE NEMOURS AND COMPANY, Wilmington, DE (US)

(72) Inventors: William Herbert Coulter, Wilmington, DE (US); Carlo Fiorella, Wilmington, DE (US); Mark Allan Lamontia, Landenberg, PA (US)

(73) Assignee: E I DU PONT DE NEMOURS AND COMPANY, Wilmington, DE (US)

(21) Appl. No.: 14/289,864

(22) Filed: May 29, 2014

Related U.S. Application Data
(60) Provisional application No. 61/835,213, filed on Jun. 14, 2013.

(51) Int. Cl. G01M 17/02

(52) U.S. Cl. CPC G01M 17/02
USPC 73/146

(57) ABSTRACT

This invention is directed to test devices and methods using subscale cylindrical laminates formed from general rubber composite plies as surrogates for full-size tires to predict how changes in the tire construction would impact tire cornering stiffness of the full-size tires.

### BACKGROUND OF THE INVENTION

1. Field of the Invention

This invention is a method of calculating how changes in tire morphology impact the tire cornering stiffness by using a subscale specimen in the shape of a cylinder instead of a full-size tire.

2. Description of the Related Art

When a vehicle is traveling in a straight line down the road, the tire's contact patch and the rim are aligned. However, when the driver turns the steering wheel, this causes the contact patch of the tire to shift laterally and to twist relative to the rim. This is illustrated graphically in FIG. 1 by the difference in alignment between wheel rim 1 and tire contact patch 2 and 2′. The extent to which the tire resists this lateral and twisting movement can be used as a measure of the tire's handling performance. To quantify this property, tire manufacturers will place full-sized tires in specialized testing machines designed to simulate the relative motion between the road and the tire as mounted on a rim and measure the tire's “cornering stiffness”. These test devices are expensive and require full-sized prototype tires to evaluate experimental concepts.

### BRIEF DESCRIPTION OF THE DRAWINGS

FIG. 1 depicts the relationship between the contact area of a tire and a rim.

FIG. 2 schematically depicts a test cylinderdevice.

FIG. 3 schematically depicts one embodiment of a testing device with a test cylinder included.

FIG. 4 schematically depicts another embodiment of a testing device with a test cylinder included.

### DETAILED DESCRIPTION OF THE INVENTION

Test devices and methods have been developed using subscale cylindrical laminates (hereafter, referred to as cylinders) formed from general rubber composite plies and/or the actual treatment used to make a tire to predict how changes in the tire construction would impact tire cornering stiffness. The invention is directed at measuring the lateral and rotational stiffness of the cylinder. An objective is to use these cylinders as surrogates for full-size tires to measure how changes in the tire crown construction influence tire performance. Building full-sized tires for testing is costly and often it is difficult isolate the contribution of a specific physical mechanism with respect to tire performance.

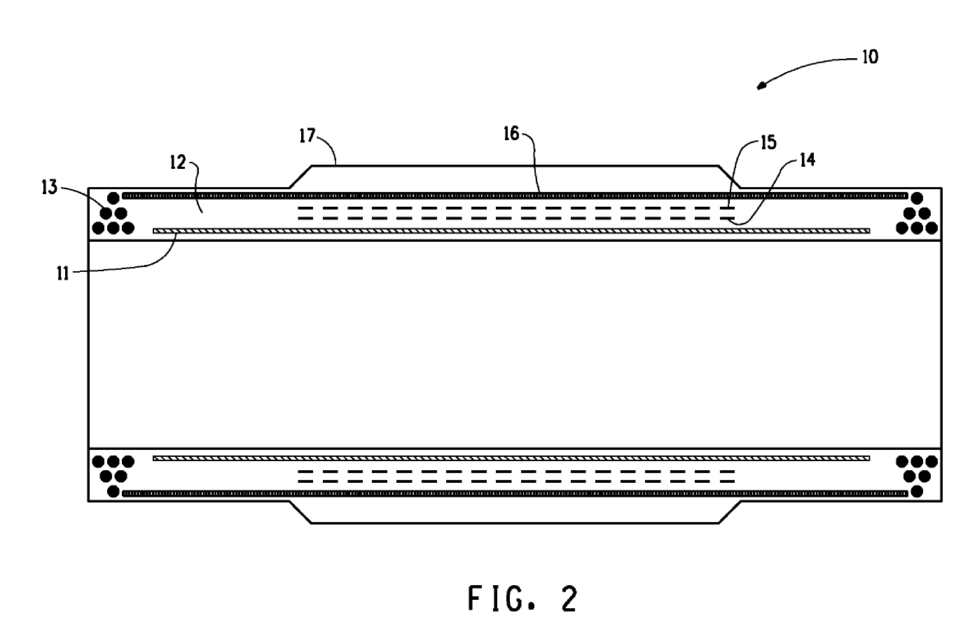

The cylinder 10 can be made with a plurality of major components as shown in cross-section in FIG. 2: carcass or ply cords 11, sidewall compound 12, beads 13, first belt 14, second belt 15, overlay 16, and tread 17. The carcass cords 11 extend just short of the beads 13. The carcass cords 11 typically would not be anchored to the beads in any way as it could interfere with the validity of the measurement. Nevertheless, such a construction could be used in some circumstances. The inner diameter of the cylinder is 5.25 inches. The length of the cylinder is 9.00 inches. The outside diameter of the cylinder varies depending on the type of tire being simulated. FIG. 2 shows a single carcass cord 11, but it is possible to have two or more carcass cords if testing of high performance or truck tires (which often have multiple plies) were required. FIG. 2 also depicts a cylinder with an overlay 16, but a cylinder can be made simulating lower speed rated passenger car tires which do not typically have overlays.

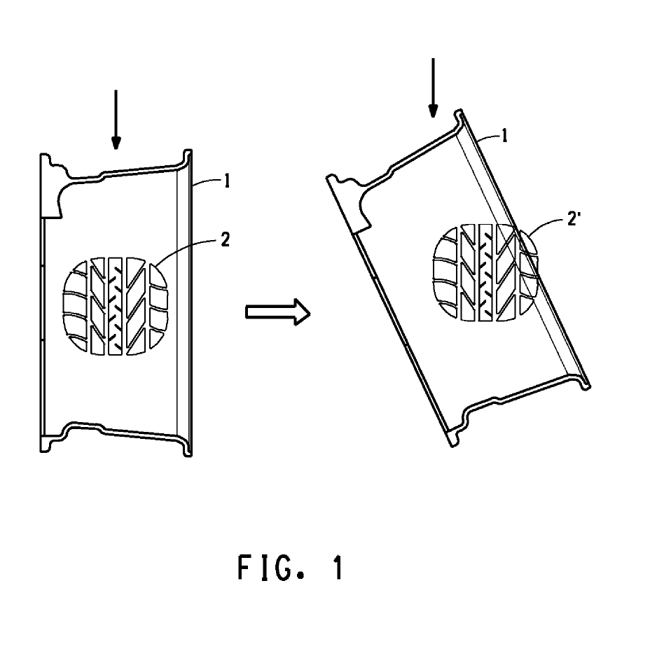

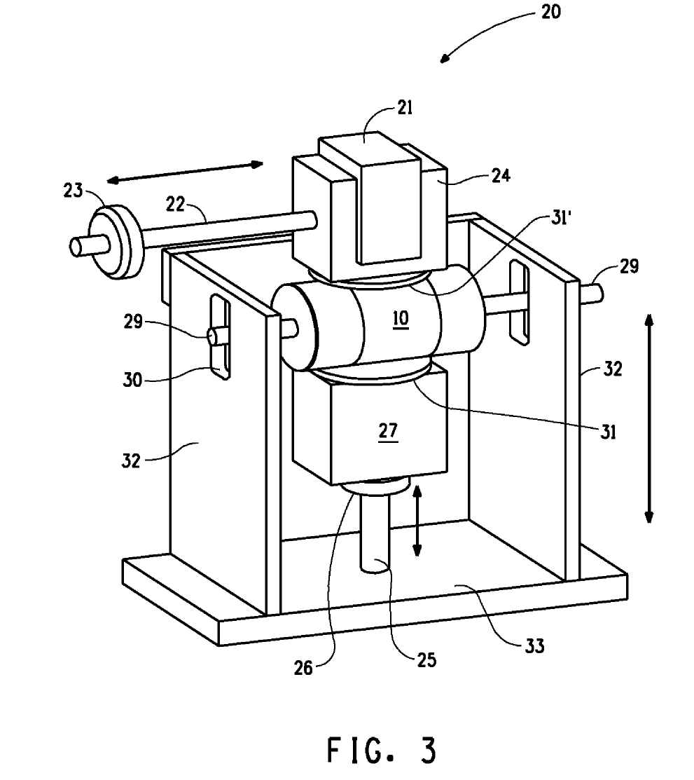

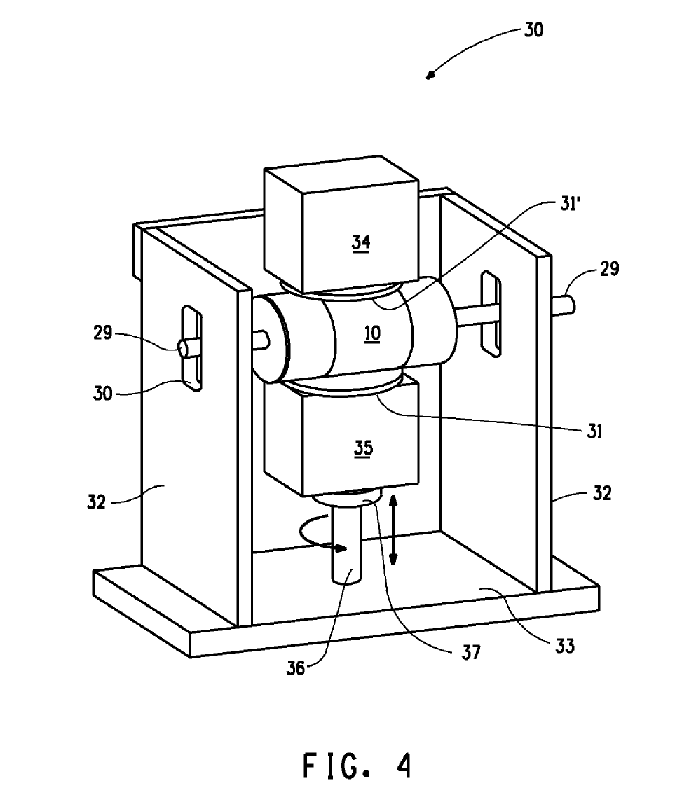

There are two different test devices that have been developed for testing the cylinder. Device 20 is shown in FIG. 3 which applies a vertical load while moving the top of the cylinder laterally with the bottom of the cylinder fixed in order to simulate the lateral motion of the contact patch relative to the rim as would be encountered in a cornering maneuver as depicted in FIG. 1. The term vertical and lateral may be used in reference to the testing devices. The top and bottom of the cylinder refers to its position as longitudinally mounted in the device and where loading plates 31 and 31′ in FIGS. 3 and 4 contact the cylinder.

Device 20

Device 20 is a multi-axial load frame capable of generating linear motion in two perpendicular axes. The device has a base 33 and parallel support rails 32. The cylinder 10 can be inflated to the appropriate working pressure and is sealed by end plates 28, which are secured with spherical ended rods 29 by fitting into a spherical receiver cup (not shown) in each end plate. The spherical ended rods 29 are able to accommodate multiple cylinder sizes. In order to inflate the cylinder, one of the end plates has an attachment point for an air line (not shown) attached to a pressure regulator (not shown). The spherical rods 29 do not allow the cylinder to move laterally, but they still allow rotation along their centerline if induced during the test. The bottom support 27 attaches to a circular loading plate 31 which has a roughened surface to simulate the road surface that would be in contact with the bottom of the cylinder. The top support 34 also attaches to a similar circular loading plate 31′ but does not require a roughened surface as it does not simulate the road surface. Computer simulations show these boundary conditions most closely approximate the rim and tire assembly on a vehicle. The vertical actuator 25 is used to apply the simulated vehicle load to the cylinder and it is fixed in place laterally. The horizontal actuator 22 is prevented from moving in the vertical direction by linear bearing plate 21 that straddles top support 24, but the actuator is allowed to move laterally as indicated by the arrow. A load cell 23 is installed to record the amount of force required to displace the actuator 22. Throughout testing, the vertical actuator 25 that applies the simulated vehicular load may move vertically to maintain the load. Support rails 32 with slots 30 allow the allow the centerline of the cylinder to move vertically, but not twist or move laterally.

The test method using device 20 is as follows:

Apply constant vertical load. As a first order approximation, it can be assumed that each tire on a four-wheeled vehicle supports approximately one-fourth of the load. This load is maintained at a constant value throughout the test.

Move actuator 22 back and forth in a triangular wave form. The magnitude of motion could be selected based on experience designing tires, use of a finite element model, or simply selecting a large value which would encompass the operating conditions. The frequency of motion is dictated by the capabilities of the hydraulic control system. Typically this frequency is less than 1 Hz.

The cycling motion can be repeated for any number of cycles. Usually, between ten and twenty are sufficient to allow the cylinder to reach steady state operation. The hydraulic actuators 22 and 25 are controlled by a computer-based control system with electronic feedback. The position of the horizontal actuator 22 is varied based on the triangular wave form described earlier. The load and position of the horizontal actuator 22 are monitored with load cell 23 and a displacement transducer that is incorporated into the load cell. The position of the vertical actuator 25 is changed to keep the vertical load constant and is measured using a displacement transducer that is incorporated into load cell 26.

All data signals (vertical load, vertical displacement, horizontal load, and horizontal displacement) are collected using a digital data acquisition system. When the testing is complete, the data can be further processed for analysis. The best way to compare the performance of two cylinders is to plot lateral load on the y-axis and the lateral displacement on the x-axis. The data will form a loop and the more vertically oriented the loop, the higher the lateral stiffness of the tire made using the cylinder construction would be. Therefore, a tire designer could use results from these test to select the construction which would yield the desired lateral stiffness.

Device 30

Device 30 as shown schematically in FIG. 4 is a multi-axial load frame, capable of applying a vertical and twisting motion simultaneously to a test cylinder 10. The device has a base 33 and parallel support rails 32. The open ends of the test cylinder 10 are sealed with end plates 28 so the cylinder can be inflated to the appropriate working pressure. End plates 28 are secured with spherical ended rods 29 by a spherical receiver cup (not shown) in each end plate. The spherical ended rods 29 are able to accommodate multiple cylinder sizes. One of the end plates has an attachment point for an air line (not shown) to which is attached a pressure regulator (not shown) in order to inflate the cylinder. Ends of the spherical rods 29 are positioned within linear slots 30. Vertical actuator 36 is attached to bottom support 35. The bottom support 35 is attached at its upper end to a loading plate 31 which has a roughened surface to simulate the road surface. The bottom support 35 is mounted to a load cell 37 capable of measuring load and torque simultaneously.

The test method using device 30 is as follows:
Apply vertical load using actuator 36. The magnitude of the load can be determined through experience selected based on experience designing tires, use of a finite element model, or by experimental investigation. The load is maintained at a constant value throughout the test using a computer control with feedback from the load cell attached to top support 18.
Rotate actuator 36 back and forth in a triangular wave form. The magnitude of motion could be selected based on experience designing tires, use of a finite element model, or simply selecting a large value which would encompass the operating conditions. The frequency of motion is dictated by the capabilities of the hydraulic control system. Typically this frequency is less than 1 Hz. A triangular wave form is the preferred embodiment, but other wave forms like a sinusoidal could be used.
The cycling motion can be repeated for any number of cycles. Usually, between ten and twenty are sufficient to allow the cylinder to reach steady state operation. The hydraulic actuator is controlled by a computer based control system with electronic feedback. The position of the vertical actuator 36 is changed to keep the vertical load constant. The angular position of the actuator is varied based on the triangular wave form described earlier. The angular displacement and vertical displacement of the vertical actuator 36 is measured by a transducer that is incorporated within the actuator itself.

All data signals (vertical load, vertical displacement, torque, and angular motion) are collected using a digital data acquisition system. When the testing is complete, the data can be further processed for analysis. The best way to compare the performance of two cylinders is to plot torque on the y-axis and the angular motion on the x-axis. The data will form a loop and the more vertically oriented the loop, the higher the lateral stiffness of the tire made using the cylinder construction would be. Therefore, a tire designer could use results from these test to select the construction which would yield the desired rotational stiffness.

1. A subscale test cylinder for testing performance characteristics of a tire, the cylinder having an inner diameter in the range of 3-10 inches, a length in the range of 5-20 inches and wherein the cylinder comprises components found in a sidewall and tread surface of a tire to be simulated, wherein the components consist of cords, belts, tread compounds, sidewall compounds and beads.

2. The cylinder of claim 2, wherein the inner diameter is 5.25 inches and the length is 9.00 inches.

3. A method for testing tire performance comprising,
a) placing a subscale test cylinder representative of a sidewall area and tread surface in a full-size tire in a testing device that incorporates an assembly adapted for accepting the test cylinder,
b) applying an axial load to the test cylinder of sufficient magnitude to represent a first order approximation of a vehicle's weight,
c) laterally translating the top of the cylinder in a range of up to plus or minus one-fourth of the test cylinder's length for a predetermined number of cycles while maintaining the bottom of the cylinder in a fixed position,
d) measuring the resulting loads and displacements for the number of cycles in step c)
e) plotting the load and displacement values to determine the resultant lateral and rotational stiffness of the subscale test cylinder.

4. A method for testing tire performance comprising,
a) placing a subscale test cylinder representative of a sidewall area and tread surface in a full-size tire in a testing device that incorporates an assembly adapted for accepting the test cylinder,
b) applying an axial load to the test cylinder of sufficient magnitude to represent a first order approximation of a vehicle's weight,
c) rotating a contact patch beneath the cylinder tangentially from the bottom surface in the range of plus 15 degrees to minus 15 degrees using a triangular wave form for a predetermined number of cycles,
d) measuring the resulting loads and displacements for the number of cycles in step (c)
e) plotting the load and displacement values to determine the resultant lateral and rotational stiffness of the subscale test cylinder.

5. A device adapted for testing a subscale test cylinder in accordance with the method of claim 3.

6. A device adapted for testing a subscale test cylinder in accordance with the method of claim 4.
